(19) United States
(12) Patent Application Publication
(10) Pub. No.: US 2014/0178548 A1
(43) Pub. Date: Jun. 26, 2014

(54) EFFICIENCY POT AND KETTLE FOR USE WITH COOKING STOVES

(71) Applicant: BioLite LLC, Brooklyn, NY (US)

(72) Inventors: Alexander H. Drummond, Austin, TX (US); Jonathan N. Cedar, Scarsdale, NY (US); Nisan H. Lerea, Bronx, NY (US); Clay Burns, New York, NY (US); Anton Olof Ljunggren, New York, NY (US)

(73) Assignee: BioLite LLC, Brooklyn, NY (US)

(21) Appl. No.: 14/080,750

(22) Filed: Nov. 14, 2013

Related U.S. Application Data
(60) Provisional application No. 61/726,221, filed on Nov. 14, 2012.

(51) Int. Cl. A47J 36/36; A23L 1/01

(52) U.S. Cl. CPC A47J 36/36; A23L 1/0121
USPC 426/478; 220/573.1; 426/509

(57) ABSTRACT

This invention provides a pot assembly for use with a stove. The system includes a lid, a pot body and an adapter assembly. The lid has a cap for accessing the contents while in use, a pour spout for dispensing the contents and a plurality of slits for use as a strainer. The pot body has folding handles that can form a triangular structure for control. The adapter assembly has an upper flame flange and a lower flame flange and baffles to directionally vector the stove's combustion gasses away from the assembly. The adapter assembly has a centering ring to engage the top of the stove and maintain stability during use. The pot assembly can be used as a storage container for the stove.

### RELATED APPLICATIONS

This application claims the benefit of U.S. Provisional Application Ser. No. 61/726,221, entitled EFFICIENCY POT AND KETTLE FOR USE WITH COOKING STOVES, by Alexander H. Drummond, Jonathan M. Cedar, Nisan H. Lerea and Clay Burns, filed Nov. 14, 2012, the teachings of which are expressly incorporated herein by reference.

### FIELD OF THE INVENTION

This invention relates to cooking pot assemblies and accessories for cooking stoves, and more particularly to cooking stoves for use in the field.

### BACKGROUND OF THE INVENTION

The use of cooking stoves is as at least as old as civilization itself. To cook or heat any food product it is generally desirable to contain it in a pot, pan, kettle or other enclosure that is capable of absorbing and spreading heat over the surface of the food product. In the case of any flowing and/or liquid-based food product, such as soup, stew, hot drinks, and the like, the ability to heat in a pot or other like cooking device is essential.

A challenge has existed for campers, and/or those travelling by foot or other conditions that necessitate lightweight carriage of supplies. A great deal of development has occurred in providing multi-use, portable, and generally lightweight cooking products. One highly effective product is the BioLite Camp Stove, produced by BioLite LLC of New York. This portable camp stove harnesses the power of generated heat from consumed biomass (e.g. wood, twigs, woodchips, etc.) to operate a thermoelectric generator (TEG) that effectively powers a fan for improved, more efficient combustion. The TEG can also provide auxiliary power to charge various electronic devices, such as cellular phones, GPS devices, and the like. A common standard, such as USB can be used to distribute such charging current.

The camp version of BioLite stove includes a top-fed combustion chamber that resides within a double-walled assembly through which air enters via injection ports from the TEG assembly. It also includes a probe that extends from the TEG assembly into the interior of the combustion chamber to provide a novel arrangement for capturing the hottest region of a flame and transferring that heat to the “hot side” of the TEG. A heat sink on the opposing “cold side” of the TEG allows airflow driven by the assembly's fan to cool the TEG before it enters the double-walled region of the combustion chamber for mixture with the fuel contained therein. The top fed opening of the BioLite Stove includes a standoff assembly that supports a pot, pan or kettle having a base with a predetermined size (perimeter or diameter). This standoff assembly includes lower and higher parts that allow combustion gasses to pass around the pot/pan/kettle. By way of example, the BioLite stove carries its TEG assembly along the side, and it is typically removable for transport and storage. While various versions allow for storage of the TEG assembly directly within the top-fed combustion chamber, this can limit the size of the assembly based on the size of the chamber. It is desirable to provide a space that allows for safe storage and transport of the TEG assembly. It is more generally desirable to provide a portable, low-profile and versatile pot or kettle that can fit the cooking surface and associated standoff assembly of the BioLite stove and other gas and/or biomass stoves. This pot assembly should allow for storage of additional accessories and enable versatile use as a cooking pot or kettle with a pour spout, among other uses. In addition, the pot assembly should allow the flame and exhaust gases (collectively termed “combustion gasses”) to exit freely from the stove, while maintaining a relatively clean interface between the pot assembly bottom and stove top. Likewise, it is desirable that the pot assembly avoids directing heat to areas that should remain cool.

### SUMMARY OF THE INVENTION

This invention overcomes disadvantages of the prior art by providing an efficiency pot and kettle for use with portable stoves that incorporates a number of features that enhance portability and allow for multi-purpose applications, such as a cooking pot, kettle with pour spout and storage compartment. The system includes a lid, pot body assembly and an adapter assembly. When the lid is fitted onto the pot body via a snap fit, it closes off the pot assembly to maximize heating.

In an illustrative embodiment, the lid is fashioned to have a removable cap that provides safe access to the interior of the pot while cooking so that the ingredients can be stirred and/or added. The lid has a pour spout that is formed to direct a stream of liquid away from the pot and provide controlled dispersal of the heated contents. The lid has a plurality of slits along the top so as to enable straining of cooked contents and contribute to an even flow when pouring liquids. The lid can be formed of a natural or synthetic polymer and be transparent, opaque or clear. The pot body is a cylindrical pot with a top opening and a bottom, with handles mounted on one side. The pot can be formed of stamped aluminum, stamped stainless steel or another durable material. In alternate embodiments, the pot can be manufactured by another process (for example, casting). The pot exterior can be anodized, painted, ceramic coated or uncoated. The exemplary pot has a height in the range of approximately 150 mm to 250 mm from the bottom to the top and a diameter in the range of approximately to 100 mm to 165 mm. The volume is therefore in the range of approximately 1 to 4 liters. The overall weight is approximately 300 grams. The pot body handles can be folded to the pot body wall, or opened to make a contact and create a triangular configuration that provides a steady and sure hold on the handles.

The adapter assembly can be removable from or fixed to the pot body. The adapter assembly is comprised of an upper flame flange; a lower flame flange, a centering ring and an intermediate baffle assembly. The upper flame flange directs and controls the combustion gasses and prevents the combustion gasses from passing along the exterior of the pot body and prevents soot deposits on the exterior of the pot body. In another embodiment, the centering ring is integrated with the upper flame flange. The lower heat flange directs the flame and heated combustion gases outward away from the power module (not shown) so as to keep that module relatively cool and prevents any downward flame movement. Notably, the position of the baffles prevents the flame exhaust from overheating the handles. The baffle assembly is an arrangement of a plurality of baffles arranged in a ring and spaced apart so that the flame can be carried out of the pot. The centering ring is sized and arranged to receive the top of the stove and to prevent lateral loss of the heated stove exhaust and helps to stabilize the pot assembly during use. Heat exhaust from combustion within the stove rises into the baffle assembly where it heats the bottom of the pot body and, indirectly, the contents of the pot, and is directed through the baffles. This movement creates a draft for the flame and ensures a controlled and steady heating for cooking To cook with the pot assembly, the user first takes off the lid and removes the contained stove. The stove is fueled and ignited. The pot body and adapter assemblies are placed onto the top of the stove using the center ring to provide a secure engagement. The contents to be heated are placed into the pot and the lid is attached by a snap fit. As the stove cooks the pot contents, the user from time to time can remove the cap, add ingredients or stir the ingredients. When the contents are cooked, the handles are used to raise the pot body and dispersal the contents through the spout. If the contents require straining, the straining lids can be used, after which the lid is removed to access and dispersal the contents. An optional serving bowl is provided that illustratively nestles within the pot body when not in use. In another embodiment, the size of the pot body can vary and be sized to include accessories and fuel. The handle can be unitary and folding. The handle can be folded to create a triangular structure that provides greater control and stability than that found in the prior art. The pot can be provided with a pair of L-shaped handles that confront each other and create a grip to control the dispensing flow of liquids from the pot. The adapter assembly can be fixed to the bottom of the pot body or removably attached thereto. The pot body exterior can be furnished with ring mounts to accommodate carrying straps or mounting points. In an alternate embodiment, the adapter ring is provided with a wall that extends below the bottom of the pot, forcing combustion gases to generate a back pressure that forces the gases through the vents with sufficient force that soot does not accumulate on the outside surface of the pot. In another embodiment, the lid assembly is constructed and arranged with a lid that is provided with a central handle on the top with cutouts on either side of the handle and situated above a concave removable cap.

### BRIEF DESCRIPTION OF THE DRAWINGS

The invention description below refers to the accompanying drawings, of which:

FIG. 1 is a side perspective view of an illustrative pot assembly according to a first embodiment;

FIG. 2 is a side perspective view of an illustrative lid for a pot assembly, according to the first embodiment;

FIG. 3 is a side perspective view of a pot body and an adapter assembly according to the first embodiment;

FIG. 4 is a detailed view of the handles for the pot body in a folded configuration, according to the first embodiment;

FIG. 5 is a top view of the handles forming a triangular structure, according to the first embodiment;

FIG. 6 is a side view of the illustrative handles forming the triangular structure, according to the first embodiment;

FIG. 7 is a detailed cross section of the adapter assembly along line 7-7 of FIG. 3 showing the directed flow of the combustion gasses through the baffles;

FIG. 8 is a detailed perspective view of a wall constructed between the upper and lower heat flanges that prevent the heat of combustion gasses from reaching the handles;

FIG. 9 is a cross section of an adapter showing a lowered wall to increase the gas pressures, according to a second embodiment;

FIG. 10 is a side view of an illustrative pot assembly, according to a third embodiment; and

FIG. 11 is an exploded perspective view of the illustrative pot assembly, according to the third embodiment.

### DETAILED DESCRIPTION

The above-described BioLite stove is shown by way of example in conjunction with the illustrative embodiment of the present invention. This stove is exemplary of a variety of possible stoves and/or cooking surfaces that the illustrative embodiment can be used together with, and should be taken as a non-limiting example. By way of useful background information, the BioLite stove is shown and described in various versions in commonly assigned U.S. Pat. No. 8,297,271, entitled PORTABLE COMBUSTION DEVICE UTILIZING THERMOELECTRICAL GENERATION, by Jonathan M. Cedar and Alexander H. Drummond, the teachings of which are expressly incorporated herein by reference.

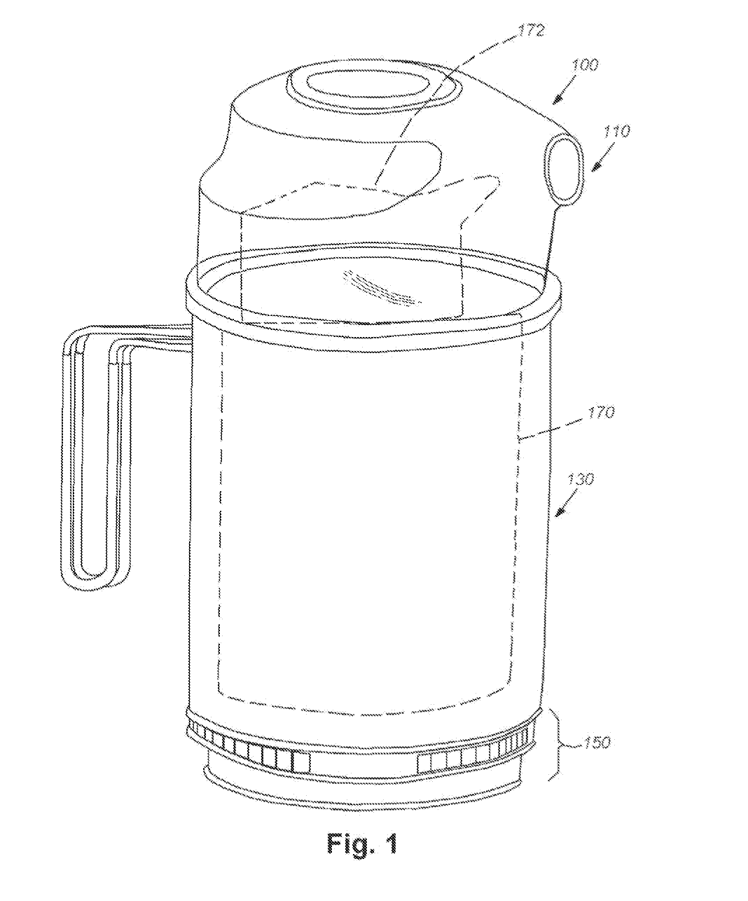

As shown in FIG. 1, the pot assembly 100 is shown in a side perspective view and is comprised of a lid assembly 110, a pot body assembly 130 and an integral adapter assembly 150. The pot assembly 100 is sized relative to the stove so that it can be employed as a protective outer container for an illustrative stove 170 (shown in broken lines).

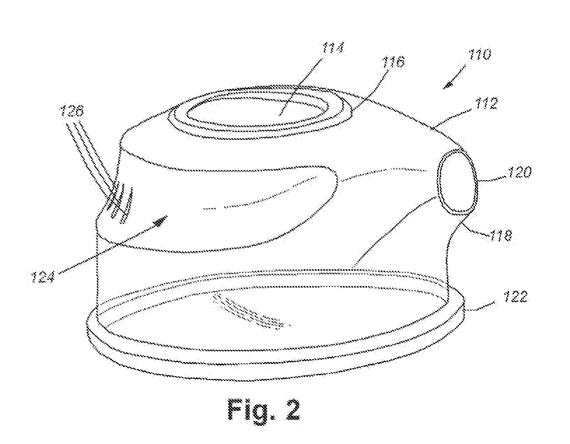

The lid assembly 110 serves to protect the stove and its power module 172 (also known as the “TEG assembly”) when the stove 170 is being stored inside the cook pot for protection and compact storage. This storage capability ensures that the contained stove is kept free from the influence of the environment, and safe from accidental damage due to dropping, etc. The lid 110 is provided with a lid body 112 and a removable cap 114 as shown in FIG. 2. The removable cap 114 resides within a lipped opening 116 in the top of the lid body 112 and is secured by a snap fit. The cap 114 can be removed to pour liquid into the cook pot and thereby minimizes the risk of spilling hot liquid from the cook pot. The cap also provides convenient access to stir the contents of the pot without the removal of the lid. The integrated spout 118 is provided with a pouring hole 120 that can dispersal heated liquids from the pot assembly 100. The top of the lid 110 is a flattened bowl in shape and the spout projects away so the dispersed liquids flow safely aware from the pot assembly 100 in a directed manner. This directed flow is particularly efficacious when dispensing heated liquids into a small container. The lower flanged ring 122 provides for a snap fit to the top of the pot body 130 and is secured with a snap fit to the top of the pot body 130. The snap fit allows a user to boil liquids as efficiently as one would do with a conventional pot lid. Other methods of securing the lid to the pot may be employed, including threads, a “bayonet” style lock, clamping mechanism or another securing assembly.

Note that the items, such as the TEG assembly, covered by the lid 112 can be supported by the top of the contained stove within the pot, or the overall assembly can include a secondary pot lid that is relatively flat and shaped in the manner of a conventional pot lid. This lid includes a rim that extends to the edge of the pot perimeter so that it is free of interference with the lid 112. Thus it “nests” within the lid 112. This lid can be constructed from metal or a heat-resistant polymer and can include a (for example) folding center handle for lifting. This lid allows the pot to be fully covered for certain cooking activities.

The body 112 has a molded detent 124 that can facilitate a user's grip on the lid 110. The detent 124 is provided with a plurality of narrow slits 126 that facilitate the use of the lid 110 as a strainer. The narrow slits provide ports through which air can enter during pouring, to improve the flow of contents through the spout. The slits enable the pot assembly 100 to be used to cook rice, pasta, vegetables and other food products that are prepared in a suspension of boiling water. The lid 100 can be constructed of a natural and/or synthetic polymer, for example, rubber or various hardened plastic products, for example polystyrene, acrylic, polycarbonate, or the like. The lid can be translucent, opaque, clear or tinted. In another embodiment, the lid is fashioned from a metallic material, for example, aluminum and/or steel, typically with a pliable gasket between the lid and pot. The lid 110 is open on the bottom so that it fully engages the top of the pot body 130.

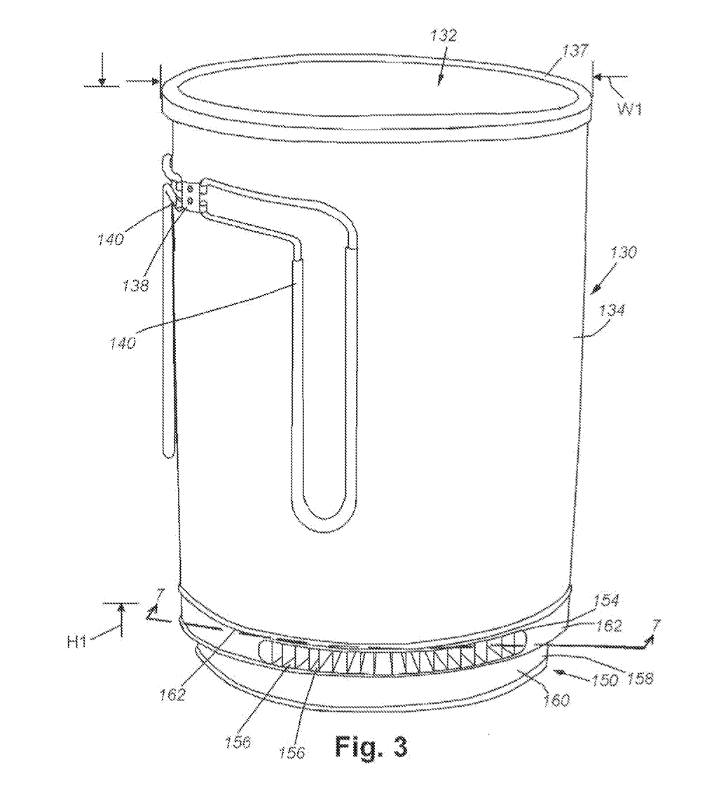

FIG. 3 depicts the pot body 130 and adapter assembly 150. The pot body 130 is a conventional pot body design, having an open top 132 with cylindrical walls 134 and a closed bottom 136. The top 132 is provided with a rolled lip 137 that is constructed and arranged to engage the bottom lip 122 of the lid 110 and secure the lid with a snap fit. The exterior of the pot 130 is provided with a handle mounting bracket 138 and two handles 140. The handles 140 can be formed from wire or stamped metal and are shaped to fold flatly against the pot when not in use. When the handles are folded out and away from the pot, they engage each other such that they form with the bracket 138 a triangular-profiled shape that creates a handle structure that prevents the pot from freely swinging. This handle structure is an advantage over the prior art. The handle structure shape provides a comfortable grip in the hand of the user and promotes a good balance with the cook pot for ease of pouring, being formed in an “L-shape”. In an embodiment, the handles can be partially covered with an elastomeric (rubberized, etc.) coating or sleeve to insulate them, so that the user avoids burns when grasping them.

The pot body 130 has a height H1 in an exemplary embodiment is in the range of approximately 150 mm to 250 mm from the bottom 136 to the top 132. The wall thickness is in an exemplary embodiment is in the range of approximately 1 mm. The diametric width W1 of the pot body 130 is uniform and in an exemplary embodiment is in the range of approximately 100 mm to 165 mm. The volume is therefore in the range of approximately 1 to 4 liters. In an embodiment, the pot body is approximately 240 mm in height and has a diameter of 130 mm, with a volumetric capacity of approximately 2 liters and an overall weight of approximately 300 grams. The pot body 130 material is stamped aluminum and is covered on its exterior with anodizing or another durable finish. In alternate embodiments, the material can be composed of stainless steel or another durable metal. The dimensions of the pot may vary larger or smaller, depending on the overall dimensions of the stove.

The adapter assembly 150 is a fixed or removable structure at the bottom of the pot body 130. The assembly is comprised of a upper flame flange 152, a circular baffle assembly 154 of evenly sized baffles 156, a lower flame flange 158 and an open ended centering ring 160. The centering ring 160 is sized and arranged to receive the top of the stove and to prevent lateral loss of the heated stove exhaust. The centering ring fully surrounds the cooking surface and stabilizes the pot assembly during use. The upper flame flange 152 directs the combustion gasses from the stove's combustion chamber outward and away from the lower edge of the cooking pot thus preventing most of the soot from the combustion gasses from blackening the vertical sides of the pot. The lower flame flange 158 directs the combustion gasses and heated combustion gases outward away from the power module (not shown) so as to keep that module relatively cool. The baffle assembly 154 is constructed and arranged so that the flame exhaust is prevented from overheating the handles. This outward direction prevents any downward movement of combustion gasses that could adversely affect the function and/or electronics of certain components, such as the cold side of a TEG assembly in the case of the BioLite stove. The baffles 156 are arranged in a ring and spaced apart so that the combustion gasses can be carried out of the pot. This function will be described more fully below.

The wall 162 is constructed to close a portion of the baffle assembly 154 and connects the upper flame flange 152 with the lower flame flange 158 along the outside of the adapter assembly 150. The wall 162 deflects heat away from the handles 140 and keeps that surrounding area relatively cool by preventing the combustion gasses from the stove from flowing underneath the handle. The centering ring 160 is attached to the lower flange and serves to position and stabilize the entire pot assembly 100 over the stove and prevent the combustion gasses from escaping out the sides of the stove's standoff assembly to direct more heat to the bottom of the pot body 130.

More particularly, and in accordance with an embodiment directed at a geometry of a cooking top like that of the BioLite, the centering ring 160 acts as a downwardly directed skirt that ensures the pot assembly's lateral motion with respect to the cooking top is restricted and that any exhaust gasses and/or flames that past through the standoff assembly are generally blocked from easily existing the sides, this the gasses pass upwardly and exit the adapter assembly via the baffles. The centering ring can have an inner diameter that is a fraction (e.g. 1/16-½) of an inch greater than the outer diameter of the stove's standoff assembly so that the pot easily drops onto and lifts off the cooking top. The vertical distance of the skirt can be between approximately ¼ and 1 inch in various embodiments.

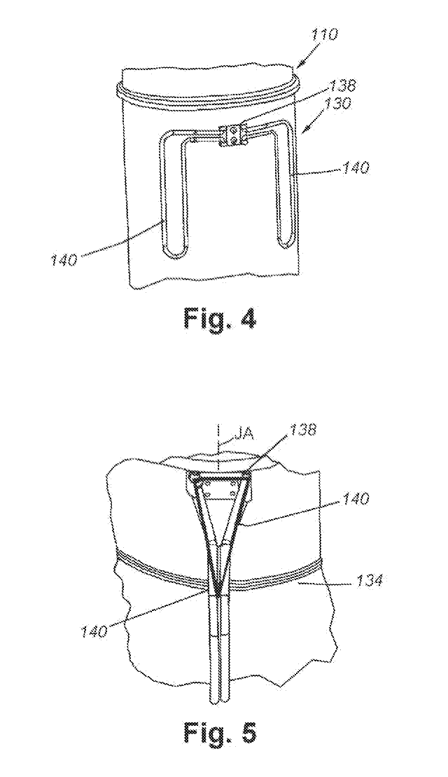

FIG. 4 is a detailed rear perspective view of the illustrative pot body 130 and depicts the handles 140 in a folded configuration. The term “folded configuration” is defined as the handles 140 being placed in close proximity to or against the pot body wall 134 to selectively reside against the pot body. Conversely, the “open configuration” is defined as the handles 140 being selectively positioned away from the wall 134 but not touching each other. The handles 140 are stored in the folded configuration. When the handles are employed, they are moved from the folded configuration through the open configuration to meet each other.

FIG. 5 is a top view of the handles making contact with each other after moving through the open configuration. The contacting handles are in the “triangular configuration” and this is defined as the position in which the handles 140 have made contact such that an axis JA drawn through the line of contact and extended towards the pot wall 134 is perpendicular to the exterior surface of the wall 134. The triangular configuration forms a stable handle to enable the safe handling of the pot.

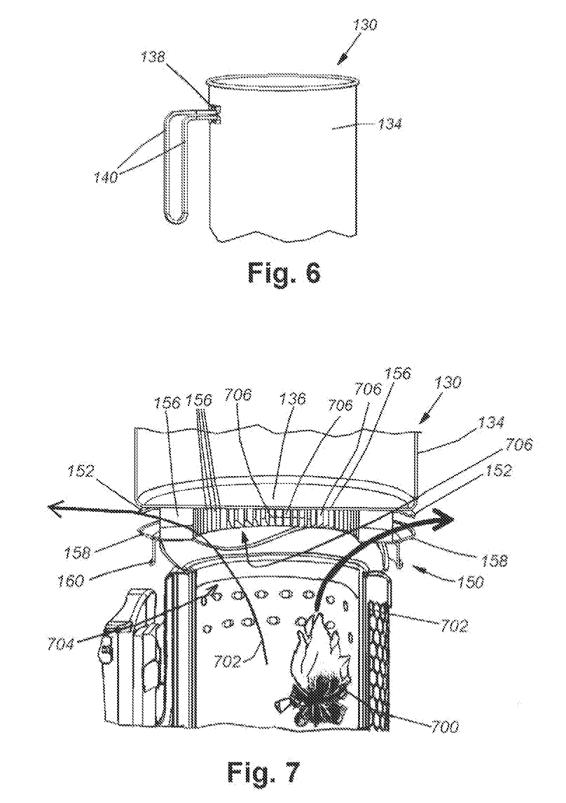

FIG. 6 is a detailed view of the top of the pot body 134 with the handles 140 folded into the triangular configuration. In an alternate embodiment, one of more of the handles has an attached moveable locking cuff that can be placed so as to retain the handles in the triangular configuration until the locking cuff is released.

FIG. 7 is a detailed partial cross section of the adapter assembly along lines 7-7 of FIG. 3. As set forth above, the combustion source 700 is emitting thermal energy in the form of combustion gasses (i.e. heat, smoke, fire and hot gas) 702. The combustion gasses 702 travel upwards towards the open mouth 704 of the stove. The centering ring 160 prevents a premature lateral thermal energy loss. As the combustion gasses passes through the open center 706 of the lower flame flange, it rises into the center of the baffle assembly 154. The combustion gasses 702 are now in proximity to the bottom 136 of the pot body 130 and some portion of the thermal energy is transferred to the bottom of the pot body and that heats the bottom of the pot body 130 and, in turn, the contents of the pot. The combustion gasses then disperse into the plurality of spaces 706 between the baffles 156 and are directionally vectored through the baffles 156 to exit the adapter assembly. The upper flame flange 152 and lower flame flange 158 direct the flow of the combustion gasses away from the exterior of the pot assembly. The passage of the combustion gasses through the baffle assembly 154 thereby causes more combustion gasses from the combustion source to be drawn upwards into the adapter assembly 150. The drawing of the combustion gasses upwards creates a fire draft and creates the efficacious steady draft that is a steady heat source for the contents of the pot body 130. The overall number of baffles, baffle thickness and number of baffles and spaces can vary greater or lesser.

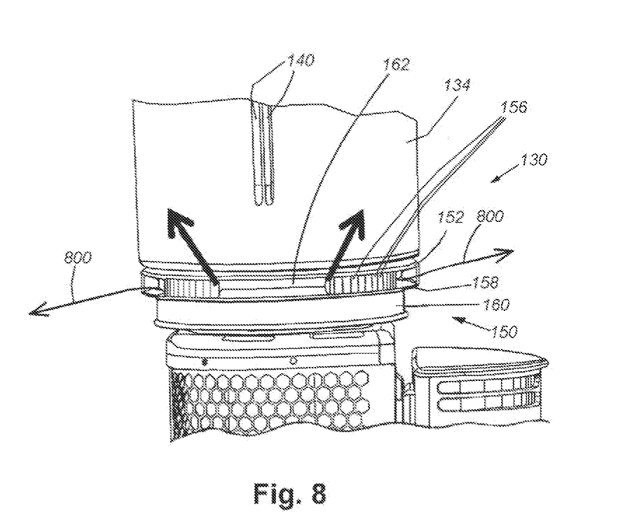

Referring now to FIG. 8, a detailed close up view of the adapter assembly 150 shows a blocking wall 162 that is positioned and attached to the upper flame flange 152 along its top and the lower flame flange 158 along its bottom. This segment of wall redirects the combustion gasses 800 laterally away from the adapter assembly 150 and prevents the heating of the handles 140, leaving them relatively cool and safe to the hand.

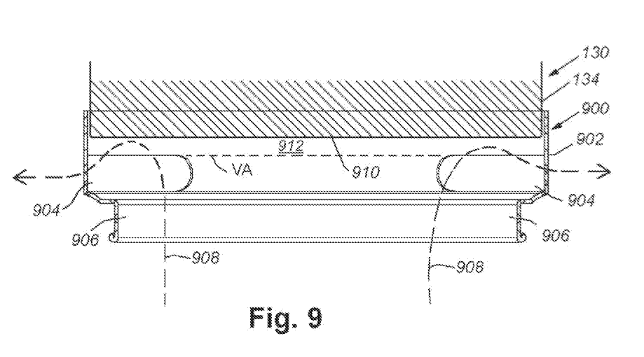

FIG. 9 depicts an alternate embodiment that includes an adapter 900 that is constructed with either an upper flame flange or lower flame flange. The adapter 900 can include a baffle assembly as set forth above, or not. The pot 134 rests in the adapter 900. The adapter ring wall 902 extends lower than the aforementioned adapter. A plurality of one or more vents 904 are provided in the adapter ring wall 902. The centering ring 906 is similar in proportion and function to that described above. The combustion gases 908 flow toward the bottom of the pot 910, above axis VA drawn across the uppermost part of the vent 904 openings. The lowered wall causes the combustion gasses to accumulate, creating a back pressure zone 912 that forces the gases down to the vents 904. The gas is thereby driven by the pressure to exit the vents rapidly; carrying combustion soot away from the pot and deterring soot build up on the bottom or sides of the pot.

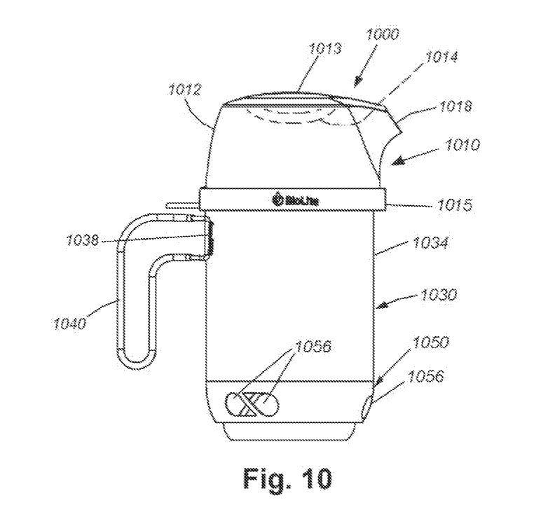

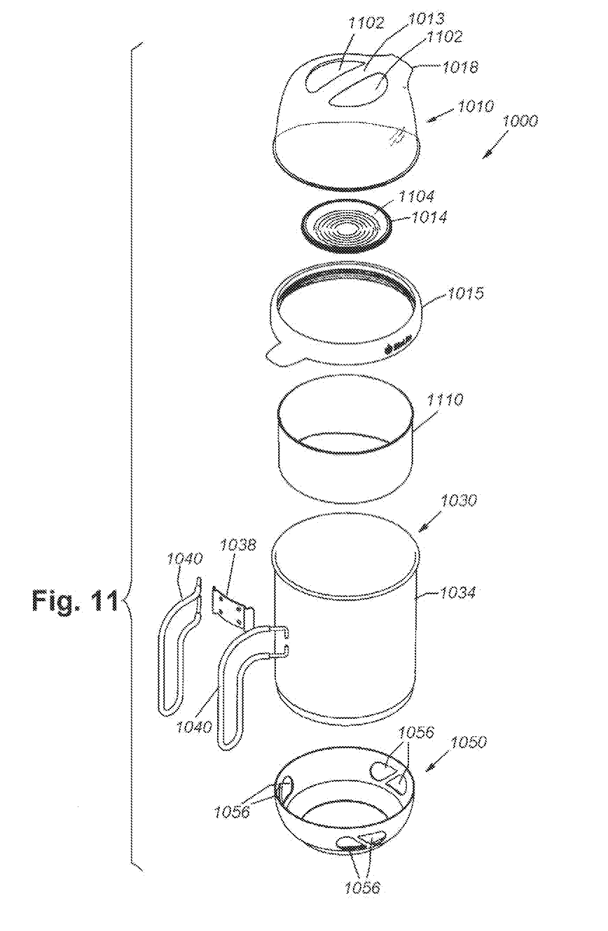

In another illustrative embodiment, a pot assembly 1000 is comprised of a lid assembly 1010, a pot body assembly 1030 and an adapter assembly 1050, as shown in FIGS. 10 and 11. Typically, the illustrative pot is similar in function, materials and dimensions as set forth above in FIGS. 1-8. Pot assembly 1000 is provided with a lid assembly 1010 that has a central top handle 1013 and an adapter assembly 1050 that is provided with a different geometry overall and in the baffles 1056. With reference to FIG. 10, the lid assembly 1010 has an integral spout 1018 that functions in the same manner as spout 110 above. The removable cap 1014 is engage able with the inside of the lid body 1012 by a “snap-fit” and can be removed during the cooking process by removing the lid assembly 1010. When the cap is not in place, the user can access the contents of the pot assembly 1000 for mixing of, stirring of or adding ingredients to those contents. The central handle 1013 is coformed with the lid body 1012 and has two cut outs 1102, as shown more particularly in FIG. 11. The cut outs provide for the access to the interior of the pot assembly 1000. The cap 1014 is situated directly beneath the central handle 1013. When the cap 1014 is in place, there is a gap between the cap and the handle 1013 that helps to keep the handle 1013 cool. The cutouts 1102 around the handle 1013 also provide for using a tool (not shown) to capture the handle and raise the lid assembly without the user making personal contact with the handle. For example, a fork can be extended such that the tines of the fork pass under the handle and provides for removable capture of the lid.

A ring 1015 is an adapter ring that holds the lid assembly 1010 in place during cooking and storage. In an embodiment, the ring 1015 is formed of silicone that is an insulator between the heat of the pot walls 1034 and the lid assembly 1010. The pot body assembly 1030 is a 1.5 liter pot and is formed of stainless steel. In other embodiments, the volume can be greater or lesser and other materials, for example, aluminum, can be used for the material of the pot body assembly 1030. The handles 1040 function as set forth above and can be coated with silicone or another material that insulates the handles from heat and provides a sure grip by the user.

An adapter assembly 1050 is an interface between the pot body assembly 1030 and the top of the stove (not shown). The baffles 1050 have the same function as set forth above and divert the combustion gases away from the vicinity of the handles. In the illustrative embodiment the baffles are shaped as pairs of nested tear-shaped holes. In other embodiments, the baffles can be circular and have a single outlet on each side or a multiplicity of more than two outlets.

The pot assembly 1000 is shown in an exploded view in FIG. 11 with its component parts. An optional serving bowl 1110 is carried within the pot assembly and is removed for cooking The serving bowl is formed of the same material as the pot body. The lid 1014 is represented as being concave and having concentric rings 1104 that can function as a self-basting lid, trapping steam and causing dripping into the pot contents and/or radiation of excess heat. The ring 1015 can be provided with a gripping tab 1106 for placement and removal of the ring from the pot body.

As used herein, “up” and “upward” are each defined as a direction taken from the adapter assembly and toward the lid with the “top” being at the approximate maximum point. “Down” and “downward” are each defined as a direction taken from the lid and toward the adapter assembly with “bottom” being at the approximate maximum point. “Interior” is defined as a region or surface facing or in the open space of the pot body 130, while “exterior” is defined as a region or surface facing away from the space of the pot body and/or residing on an outside surface of the pot body, lid and/or adapter assembly and exposed to the outside environment. More generally, as used herein the directional terms, such as, but not limited to, “up” and “down”, “top” and “bottom”, “inside” and “outer”, “front” and “back”, “inner ” and “outer”, “interior” and “exterior”, “downward” and “upward”, “horizontal” and “vertical” should be taken as relative conventions only, rather than absolute indications of orientation or direction with respect to a direction of the force of gravity.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, the handle can be a folding unitary member. The adapter assembly can be fixed to the bottom of the pot body or removably attached thereto. A taller pot can be provided for storage of the stove and additional accessories and/or fuel. The pot body exterior can be furnished with ring mounts to accommodate carrying straps or mounting points. In another embodiment, the lid can additionally function as a bowl. The bowl lid can be provided with steam vents instead of a spout (or other access ports) and with or without a removable access port. The lid can then be constructed and arranged as a closed serving bowl. The lid can also be metal and constructed and arranged in a shape of at least one of a fry pan and a small scale cooking pot. Accordingly, this description is meant to be taken only by way of example, and not to otherwise limit the scope of this invention.

What is claimed is:

1. A pot assembly comprising:
a removable lid;
a pot body having an open top and a closed bottom; and
an adapter assembly, including upper and lower flame flanges, a centering ring, and a baffle assembly therebetween, each for directing combustion gasses away from the stove and sides of the pot body.

2. The pot assembly as set forth in claim 1 wherein the pot capacity is approximately 2 quarts.

3. The pot assembly as set forth in claim 1 wherein the lid defines a pour spout and includes a removable cap that provides access to the contents of the pot during cooking

4. The pot assembly as set forth in claim 1 wherein the lid includes a plurality of slits constructed and arranged to provide a strainer that drains liquids from the contents of the pot.

5. The pot assembly as set forth in claim 1 wherein the pot body includes a pair of folding handles that, in a folded position, reside in each of opposing directions along a side of the pot body and in an unfolded position reside in a confronting orientation.

6. The pot assembly as set forth in claim 5 wherein the handles, in the confronting orientation, define a triangular configuration that provides a stable handle for controlling the pot body.

7. The pot assembly as set forth in claim 1 wherein the lid is constructed and arranged to be secured to the pot body by a snap fit.

8. The pot assembly as set forth in claim 1 wherein the adapter assembly is either fixed to the bottom of the pot body or is removably attached to the bottom of the pot body.

9. The pot assembly as set forth in claim 1 wherein the centering ring is constructed an arranged to provide a removable and centered attachment to the cooking top of the stove.

10. The pot assembly as set forth in claim 1 wherein the adapter is constructed and arranged to pass the combustion gasses from the stove through the adapter assembly and to transfer thermal energy to the pot body.

11. The pot assembly as set forth in claim 10 wherein the upper flame flange is constructed and arranged to prevent the combustion gasses from passing upward along an exterior side of the pot body.

12. The pot assembly as set forth in claim 10 wherein the combustion gasses are directed outward through the baffle assembly.

13. The pot assembly as set forth in claim 1 wherein the lower flame flange is constructed and arranged to prevent a downward movement of the combustion gasses and to prevent the combustion gasses from contact with the stove and stove accessories.

14. The pot assembly as set forth in claim 1 wherein the pot body is constructed and arranged to receive, and contains, at least one of the stove and accessories for the stove.

15. The pot assembly as set forth in claim 14 wherein the lid defines a space constructed an arranged to house accessories of the stove.

16. The pot assembly as set forth in claim 15 wherein the accessories include a removable TEG assembly.

17. The pot assembly as set forth in claim 1 wherein the adapter assembly includes a wall between each of the upper flange assembly and the lower flange assembly located about a portion of a perimeter thereof for blocking escape of combustion gasses beneath a location of handles attached to the pot body.

18. The pot assembly as set forth in claim 1 wherein the lid is dome-shaped and constructed and arranged as a closed serving bowl.

19. The pot assembly as set forth in claim 1 wherein the lid is metal and constructed and arranged in a shape of at least one of a fry pan and a small scale cooking pot.

20. The pot assembly as set forth in claim 1 wherein the pot is provided with a pair of movable L-shaped handles that reside against the pot and move to confront each other and create a grip to control the dispensing flow of liquids from the pot.

21. The pot assembly as set forth in claim 1 wherein the lid is constructed and arranged with a central handle located on the top.

22. The pot assembly as set forth in claim 21 wherein the lid is constructed with a removable cap situated beneath the central handle.

23. The pot assembly as set forth in claim 22 further comprising a blocking wall constructed and arranged in the baffle assembly to prevent transfer of heat to handles located along the exterior side.

24. A pot assembly comprising:
a removable lid;
a pot body having an open top and a closed bottom; and
an adapter assembly including a wall and a centering ring that removably engages a cooking top of a stove, the adapter assembly being constructed and arranged to generate a backpressure and directing combustion gasses away from the stove and sides of the pot body through vents along the wall.

25. A method for cooking using a pot assembly comprising the steps of:
removing the lid to remove the stored stove from the pot body;
placing fuel into the stove;
igniting the fuel to create combustion gasses;
engaging the stove top with the centering ring attached to the bottom of the pot body;
filling the pot body with the contents to be heated;
placing the lid onto the top of the pot body; and
dispersing the heated contents of the pot assembly through the pour spout.

26. The method for cooking using a pot assembly of claim 25 wherein the heated contents are strained and the lid is removed for dispersal of the contents.
